(19) United States
(12) Patent Application Publication
(10) Pub. No.: US 2007/0046443 A1
(43) Pub. Date: Mar. 1, 2007

(54) Rearview mirror having an alarm

(76) Inventors: Yao Ying Zhang, Montreal (CA); Mikio Shimada, Nagoya City (JP)

Correspondence Address: TROXELL LAW OFFICE PLLC;SUITE 1404, 5205 LEESBURG PIKE, FALLS CHURCH, VA, 22041, US

(21) Appl. No.: 11/214,873

(22) Filed: Aug. 31, 2005

(51) Int. Cl. B60R 25/10; G02B 5/08

(52) U.S. Cl. 340/426.24; 359/843

(57) ABSTRACT

A rearview mirror having an alarm used in a car is disclosed. The rearview mirror comprises a mirror case and a lens. The burglarproofing alarm is disposed in the rearview mirror integrated together with the rearview mirror since a sensor device and an alarm-raising device are communicatively connected to a central control circuit in the mirror case.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

The Present invention pertains to a rearview mirror used in a car. More particularly, the present invention pertains to a rearview mirror having an alarm used in a car, the rearview mirror comprising a mirror case and a lens and a burglarproofing alarm being disposed in the rearview mirror integrated together with the rearview mirror with a sensor device and an alarm raising device being communicatively connected to a central control circuit in the mirror case.

2. Background

In a car, a rearview mirror is generally disposed on a windscreen so that the driver of the car may see the view in rear of the car. In fact, the rearview mirror is generally disposed at a position where the driver may see each corner of the car.

In addition, an acoustic alarm is often installed in a car so that the burglarproofing purpose may be achieved. At present, the alarm and the rearview mirror in a current car are separately disposed in the car.

3. Description of Prior Art

It is, therefore, an object of the present invention to provide a rearview mirror having a burglarproofing alarm used in a car.

According to an aspect of the present invention, the rearview mirror having an alarm comprises a mirror case and a lens. The rearview mirror has the burglarproofing alarm disposed therein and the burglarproofing alarm comprises a sensor device, an alarm raising device and a central control circuit, the sensor device and the alarm-raising device being communicatively connected to the central control circuit.

In addition, the sensor device comprises a pneumatic transducer, which is connected to the central control circuit.

In addition, the sensor further comprises an active human body infrared transducer, which has a sensing portion disposed outside the mirror case.

According to another aspect of the present invention, the mirror case has a matching portion used for fixation of the rearview mirror.

According to another aspect of the present invention, the alarm has a remote control, which has a buzzer and/or a vibration motor. When the alarm is enabled, the buzzer and/or vibration motor are enabled concurrently. Preferably, a display window is provided on the remote control so that the central control circuit may control a display showing a message indicating a human body has been sensed by the active human body infrared transducer.

In addition, the rearview mirror further comprises a power line configured to be connected to an outlet of a cigarette igniter in the car.

In addition, the rearview mirror further comprises a loudspeaker and a telephone transmitter connected to a cellular phone through a connection line as a hands-free device for the cellular phone.

In addition, the sensor device further comprises an ultrasonic transducer.

Since the alarm and the rearview mirror are integrated, the alarm may be installed at a preferable position in the car where the rearview mirror is generally disposed. As such, the alarm and rearview mirror combination may be easily installed and a burglarproofing effect may be efficiently achieved.

### SUMMARY OF INVENTION

A rearview mirror having an alarm used in a car is disclosed. The rearview mirror comprises a mirror case and a lens. The burglarproofing alarm is disposed in the rearview mirror integrated together with the rearview mirror since a sensor device and an alarm-raising device are communicatively connected to a central control circuit in the mirror case.

### BRIEF DESCRIPTION OF THE DRAWINGS

The invention will become more fully understood from the detailed description given below as an illustration only, and thus is not limited of the present invention, and wherein:

FIG. 1 is a front view of a rearview mirror having an alarm used in a car according to a first embodiment of the present invention;

FIG. 2 is a rear view of the rearview mirror having an alarm used in a car according to a first embodiment of the present invention;

FIG. 3 is a perspective view of a remote control used with the rearview mirror having an alarm according to the present invention;

FIG. 4 is display frames of a display window on the remote control each showing corresponding exceptions, respectively, according to the present invention.

### DETAILED DESCRIPTION OF THE INVENTION (PREFERRED EMBODIMENTS)

### First Embodiment

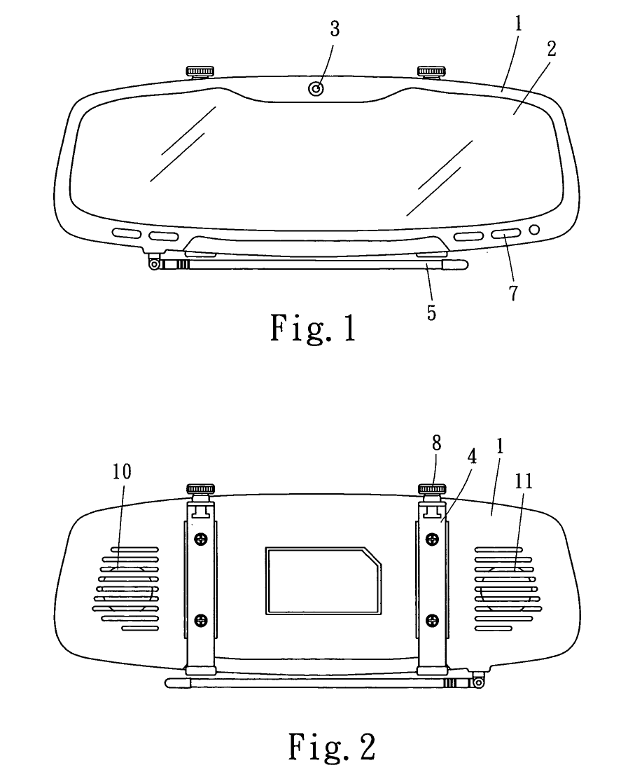

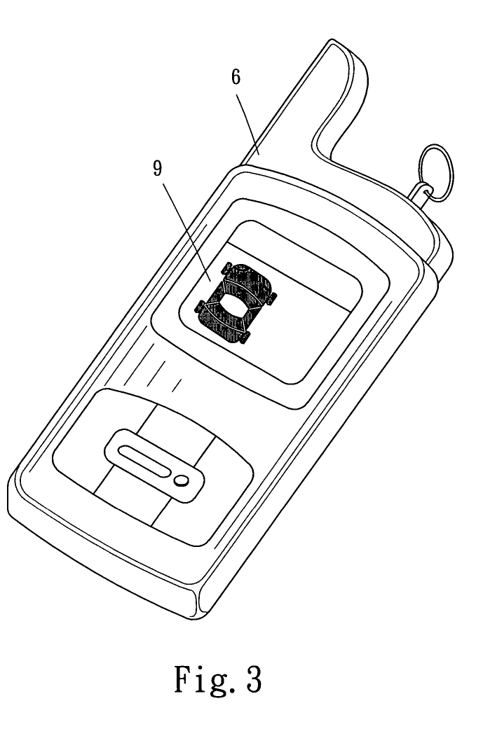

Referring to FIG. 1, a front view of a rearview mirror having an alarm used in a car according to a first embodiment of the present invention is shown therein; the rearview mirror is the kind currently existing. As shown, the rearview mirror has a mirror case 1 and a lens 2 disposed at a front side of the mirror case 1. Within the mirror case 1, a burglarproofing alarm is disposed, which comprises a central control circuit, a sensor device and an alarm-raising device, the sensor device and alarm-raising device being communicatively connected to the central control circuit.

In this embodiment, the sensor device comprises a pneumatic transducer (now shown) and an active human body infrared transducer 3. The active human body infrared transducer 3 has a sensing portion, which is disposed outside the mirror case 1.

The pneumatic transducer is used to sense a deviation of air pressure through a piezoelectric element therein. By means of an amplifying circuit, a digital signal associated with the air pressure deviation may be directly outputted. Such pneumatic transducer is suitable to be used in a close space, such as a car. Once any air pressure deviation takes place in the car, the pneumatic transducer issues a signal to the central control circuit. With sensing precision, the current pneumatic transducer may sense a minimum pressure deviation up to 1 Pa.

Unlike the general infrared transducer, the active human body infrared transducer 3 may actively sense any infrared ray emitted from a human body and then output a corresponding electric signal. It is to be noted that the active human body infrared transducer 3 may be considerably benefited when being positioned at the rearview mirror. Referring to FIG. 1, a sensing portion of the active human body infrared transducer 3 is disposed on the rearview mirror 3. As such, any invasion event in the car within a range beyond 90 degrees in front of the alarm 90 may be detected and caught.

Signals outputted from the pneumatic transducer and active human body infrared transducer 3 is transmitted through signal lines to the central control circuit. Then, the central control circuit determines if the alarm should be activated based on analysis of the inputted signals.

The alarm may possibly issue an alarm signal improperly, for instance, when increase or decrease of temperature causes a pressure variation in a close space. To avoid the improper alarm from being raised, an initial state, such as temperature when a user leaves a room or the car, of the pneumatic transducer may be kept in memory by the central control circuit. This data is taken as a reference so that future acquired data and the reference data may be compared. Based on the comparison result, the inputted signal to the central control circuit may be determined if it has reached a level beyond a reasonable range. In this manner, the alarm may be reasonably determined if it should be really activated.

Similarly, the active human body infrared transducer is also equipped with the analysis and determination mechanism. Specifically, the wavelength of the infrared ray emitted from the human body may be kept in memory. As such, the wavelength of the infrared ray emitted from other organisms may be avoided from miss-activating the alarm. Based on this mechanism, reliability of the alarm of this invention is enhanced.

It is also to be noted that the pneumatic transducer and active human body infrared ray transducer 3 may be alternatively used. That is, the user may operate a button 7 disposed on the mirror case 1 to select if the pneumatic transducer or the active human body transducer should be activated. Alternatively, the two transducers may be activated concurrently. Although the two transducers are preferably used as the sensor device in the rearview mirror, other transducers are also contemplated in this invention, such as an audio transducer and an ultrasonic transducer.

Furthermore, a matching portion 4 is provided on the mirror case 1 of the rearview mirror so that the rearview mirror may be mated to a general rearview mirror in a car. Specifically, a screw nut 8 is disposed on the matching portion 4 and thus the inventive and general rearview mirror may be attached together.

Preferably, the burglarproofing alarm may include a remote control 6 and an antenna 5 is disposed corresponding to the remote control 6 on the mirror case 1. The remote control 6 may be used to activate/deactivate the burglarproofing alarm at a remote end. When the user is away from the car at a specific distance, he may send a signal to activate the alarm through the remote control 6. When the user is near the car, he may send another signal to deactivate the alarm. Alternatively, the user may activate or deactivate the alarm manually through the remote control 6. As such, the remote control 6 may be automatically activated or deactivated without the need of a direct manual operation.

When an exception occurs, the alarm sends a signal to the remote control 6 requesting the vibration motor or buzzer in the remote control 6 to operate. In this manner, the user may be notified with the occurred exception. By means of the pneumatic and active human body infrared transducer 3, the central control circuit may determine which kind of exception has taken place. As examples, the exception may be a car window being damaged, car door being opened, car body being bumped and car being invaded. Preferably, the remote control 6 may also comprise a liquid crystal display (LCD) window 9 so that the exception may be displayed to the user through the LCD window 9.

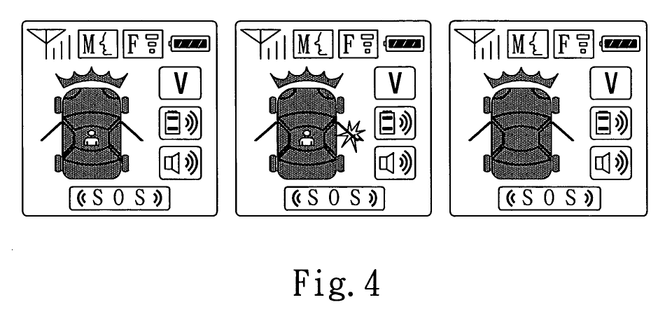

FIG. 4 shows display frames of a display window on the remote control displaying exemplary exceptions of the car, respectively. As shown, the left figure shows a flickering opened car door portion indicating the car door has been opened. The middle figure indicates the car window has been damaged or the car body has been bumped. The right figure shows a flickering driver seat portion indicating the car has been invaded. Through the exception displayed on the remote control 6, the user may perceive what exception has occurred.

In addition, a wire extension may be provided to the alarm so that the wire extension may be connected to a smoke igniter in the car. In this manner, the alarm may be charged so that it may operate normally.

Preferably, the rearview mirror may be provided with a circuit so that a hands-free device for a cellular phone may be achieved. Specifically, inside the rearview mirror there is a loudspeaker and a telephone transmitter, which may be connected to the cellular phone through a connection line. As such, the user may use the cellular phone through the hands-free device. The user may be perfectly benefited with the hands-free device since it is disposed at a position opposite to the driver where the rearview mirror is installed and thus the use of the hands-free device is considerably convenient.

In addition, an automatic dialing device may be disposed in the alarm of the rearview mirror so that the automatic dialing device may dial a predetermined telephone number through the as-connected cellular phone to inform the user about the exception when the remote control may not be communicatively connected or found. More preferably, a plurality of telephone numbers may be used in place of the predetermined number so that other telephone numbers may be dialed when a telephone corresponding to one of the predetermined telephone numbers is busy or without answering.

### Second Embodiment

In this embodiment, an alarm is formed integrally with the rearview mirror disposed on a windscreen of the car when the car is manufactured. Likewise, the alarm comprises a central control circuit, a sensor device and an alarm raising device, the sensor and alarm raising devices being communicatively connected to the central control circuit and the sensor device comprising the pneumatic transducer and the active human body transducer.

It is to be noted that those may obtain variations and modifications of the rearview mirror skilled in the art with benefit from the above-described embodiments, which are merely given for illustrations. For example, a general audio transducer may be utilized as the sensor device. In this regard, the invention should be construed in the broadest sense and thus scope and spirit of the above invention will be rendered in the following claims.

What is claimed is:

1. A rearview mirror having a burglarproofing alarm used in a car and comprising a mirror case and a lens, characterized in that said rearview mirror has said burglarproofing alarm disposed therein and said burglarproofing alarm comprises a sensor device, an alarm raising device and a central control circuit, said sensor device and said alarm raising device being communicatively connected to said central control circuit.

2. The rearview mirror according to claim 1, wherein said rearview mirror is further characterized in that said sensor comprises a pneumatic transducer disposed in said mirror case and connected communicatively to said central control circuit.

3. The rearview mirror according to claim 1, wherein said rearview mirror is further characterized in that said sensor device comprises an active human body infrared transducer having a sensing portion disposed outside of said active human body infrared transducer.

4. The rearview mirror according to claim 1, wherein said rearview mirror is further characterized in that said mirror case comprises a matching portion for fixation of said rearview mirror.

5. The rearview mirror according to claim 1, wherein said rearview mirror is further characterized in that said alarm further comprises a remote control having at least one buzzer and a vibration motor, wherein said central control circuit activates at least one of said buzzer and vibration motor concurrently when activating said alarm.

6. The rearview mirror according to claim 5, wherein said rearview mirror is further characterized in that said remote control has a display window through which said central control circuit displays a human body position has been detected by said active human body infrared transducer.

7. The rearview mirror according to claim 1, wherein said rearview mirror is further characterized in that said rearview mirror further comprises a power line configured to be connected to an outlet of a smoke igniter in the car so that said alarm is charged through said power line.

8. The rearview mirror according to claim 1, wherein said rearview mirror is further characterized in that said mirror case has a loudspeaker and a transmitter disposed therein, connected through a connection line to a cellular phone so that said mirror case forms a hand-free device of said cellular phone in the car.

9. The rearview mirror according to claim 3 (recommended), wherein said rearview mirror is further characterized in that said sensor device further comprises an ultrasonic transducer.
